(19) United States
(12) Patent Application Publication
(10) Pub. No.: US 2007/0089558 A1
(43) Pub. Date: Apr. 26, 2007

(54) Force multiplying structure for ram actuated devices

(76) Inventor: Myron D. Tupper, Boring, OR (US)

Correspondence Address: MANELLI DENISON & SELTER, 2000 M STREET NW SUITE 700, WASHINGTON, DC, 20036-3307, US

(21) Appl. No.: 11/580,881

(22) Filed: Oct. 16, 2006

Related U.S. Application Data
(60) Provisional application No. 60/729,203, filed on Oct. 24, 2005.

(51) Int. Cl. G05G 1/04

(52) U.S. Cl. 74/516

(57) ABSTRACT

A force multiplying structure includes a central cam 132 associated with an output shaft 28. A first link structure 114 has one end pivotally coupled to a first member 112 of a tool and another end is pivotally coupled to the central cam 132. A first roller 30′ is associated with the first link structure 114 and rotates on the cam surface 130 of the first member 112 and on a surface of the central cam 132. A second link structure 118 has one end pivotally coupled to a second member 122 of a tool and another end is pivotally coupled to the central cam 132. A second roller 30″ is associated with the second link structure and rotates on the cam surface 138 of the second member and on a surface of the central cam 132. Movement of the output shaft causes the first and second link structures to move, causing the first member 112 to move and engage the object with a force increased from a force exerted by the output shaft. The rollers carry loads exerted on the first and second link structures.

This application claims the benefit of the earlier filing date of U.S. Provisional Application No. 60/729,203, filed on Oct. 24, 2005, which is incorporated by reference herein in its entirety.

### FIELD OF THE INVENTION

The invention relates to crimping tools and, more particularly, to a force multiplying structure that provides sufficient force, for example, to crimp or swage an object.

### BACKGROUND OF THE INVENTION

A device described in U.S. Pat. No. 6,341,621 provides high force to an output shaft or ram due to a relatively small force applied to an input shaft. Many applications of this device require a nonlinear, increasing force with respect to travel of a ram. A well-known mechanism that produces a nonlinear, increasing leverage is a double link, hinged in the middle. However, in such mechanisms, pivots at the ends of the links must carry an excessive load and thus can fail.

There is a need to provide force multiplying structure for multiplying the output of a device of the type disclosed in U.S. Pat. No. 6,341,621 wherein the links do not carry an excessive load.

### SUMMARY OF THE INVENTION

An object of the invention is to fulfill the need referred to above. In accordance with the principles of the present invention a force multiplying structure is provided for multiplying force from an output shaft to a tool. The tool includes first and second members with at least one of the members being a movable member to exert the multiplied force on an object. Each of the first and second members has a cam surface. The force multiplying structure includes a central cam associated with the output shaft. A first link structure has one end pivotally coupled to the first member and another end pivotally coupled with respect to the central cam. A first roller is associated with the first link structure for rotation with respect thereto. The first roller is disposed so as to rotate on the cam surface of the first member and on a surface of the central cam. A second link structure has one end pivotally coupled to the second member and another end pivotally coupled with respect to the central cam. A second roller is associated with the second link structure for rotation with respect thereto. The second roller is disposed so as to rotate on the cam surface of the second member and on a surface of the central cam. Movement of the output shaft causes the first and second link structures to move thereby causing the movable member to move and engage the object with a force increased from a force exerted by the output shaft, with the rollers carrying loads exerted on the first and second link structures.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawing, in which:

FIG. 1 is a schematic side view of a force multiplying structure provided in accordance with the principles of the present invention, shown coupled to a crimping tool disposed in an opened position.

FIG. 2 is a view of the force multiplying structure and the crimping tool of FIG. 1, with the crimping tool shown in closed position.

FIG. 3a is a schematic view of a link structure of the force multiplying structure and the upper jaw of the crimping tool of FIG. 1, shown during a first closing process wherein force at the crimping tool is about 4.2 pounds.

FIG. 3b is a schematic view of a link structure of the force multiplying structure and upper jaw of the crimping tool of FIG. 1, shown during a second closing process wherein force at the crimping tool is about 9 pounds.

FIG. 3c is a schematic view of a link structure of the force multiplying structure and upper jaw of the crimping tool of FIG. 1 shown during a third closing process wherein force at the crimping tool is about 134 pounds.

FIG. 3d is a schematic view of a link structure of the force multiplying structure and upper jaw of the crimping tool of FIG. 1, shown in a fully closed position wherein force at the crimping tool is about 2500 pounds.

FIG. 4 is a perspective view of the force multiplying structure provided in accordance with another embodiment of the invention coupled with a linearly moved crimping tool and shown with the crimping tool in a closed position.

FIG. 5 is a side cross-sectional view of the force multiplying structure of FIG. 4.

FIG. 6 is a side cross-sectional view of the force multiplying structure of FIG. 4, but shown with the crimping tool in an opened position.

### DETAILED DESCRIPTION OF THE PREFERRED EXEMPLARY EMBODIMENTS

As noted above, there is a need to provide force multiplying leverage structure for the output of a device of the type disclosed in U.S. Pat. No. 6,341,621, the contents of which is hereby incorporated by reference into this specification. The device described in U.S. Pat. No. 6,341,621 provides high force to an output shaft or ram due to a relatively small force applied to an input shaft. Alternatively, any type of machine using a ram or linear actuator could make use of the force multiplying structure described below to multiply force.

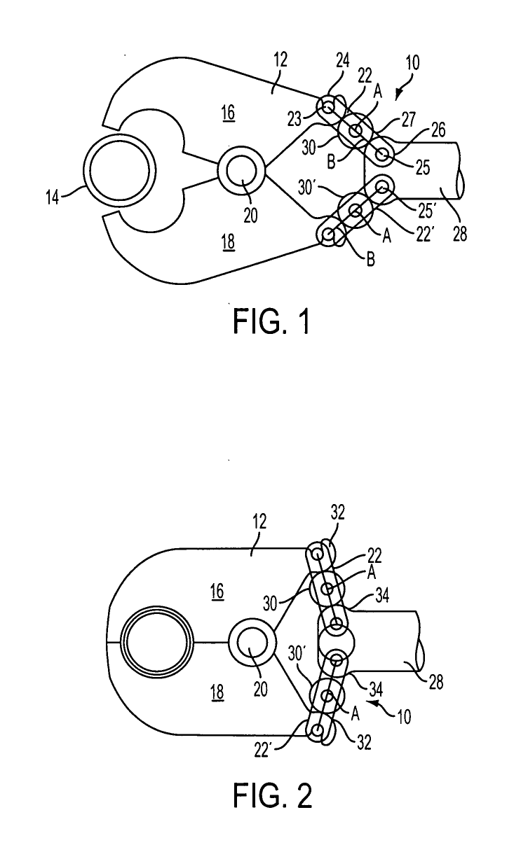

With reference to FIGS. 1 and 2, a force multiplying structure, generally indicated at 10, is shown in accordance with the principles of an embodiment of the present invention. The structure 10 is shown coupled to a crimping tool 12 of the type for crimping an object such as swaging wire rope or cable 14. The tool 12 has a first member such as an upper jaw 16 and a second member such as a lower jaw 18 coupled thereto via a pivot connection 20. The force multiplying structure 10 includes a fist link structure 22 and a second link structure 22′. Link structure 22 is coupled to jaw 16 and link structure 22′ is coupled to jaw 18. The link structures 22 and 22′ are identically configured. Thus, only the configuration of link structure 22 will be described herein.

Link structure 22 is pivotally coupled via connection 23 at one end 24 to the jaw 16 with the other end 26 being pivotally coupled via connection 25 to an output shaft 28, such as the output shaft of the tool of the U.S. Pat. No. 6,341,621 patent, or of the output shaft of the tool described in commonly owned, U.S. patent application Ser. No. 11/401,314, the contents of which is hereby incorporated by reference into the present specification. In the embodiment, the link structure 22 includes a pair of links (only one link 27 is shown in FIGS. 1-3d) provided in spaced relation with at least one roller 30 provided between the links 27 of the pair.

The roller 30 is preferably of elongated cylinder type and is mounted to the links 27 for rotation about axis A (e.g., transverse with respect to link axis B). The roller 30 ensures that the connections 23 and 25 at the ends of the link structure 22 do not carry an excessive load. The links 27 preferably have slotted holes at the connections 23 and 25 thereof that permit the roller 30, not the links, to carry the entire load. The links 27 are important in that they are needed to keep the roller 30 on a centerline between cam surfaces 32, 34 that they roll on. There is very little force that would cause the rollers to move off of this centerline.

With reference to FIG. 1, since the connection 25 of link structure 22 and the connection 25′ of link structure 22′ are connected to the same object, namely the shaft 28, these connections can be considered to be the same connection. Furthermore, the end of shaft 28 can be considered a central cam since it includes a cam 34 associated with each roller 30, 30′ and is dispend between the jaws 16 and 18.

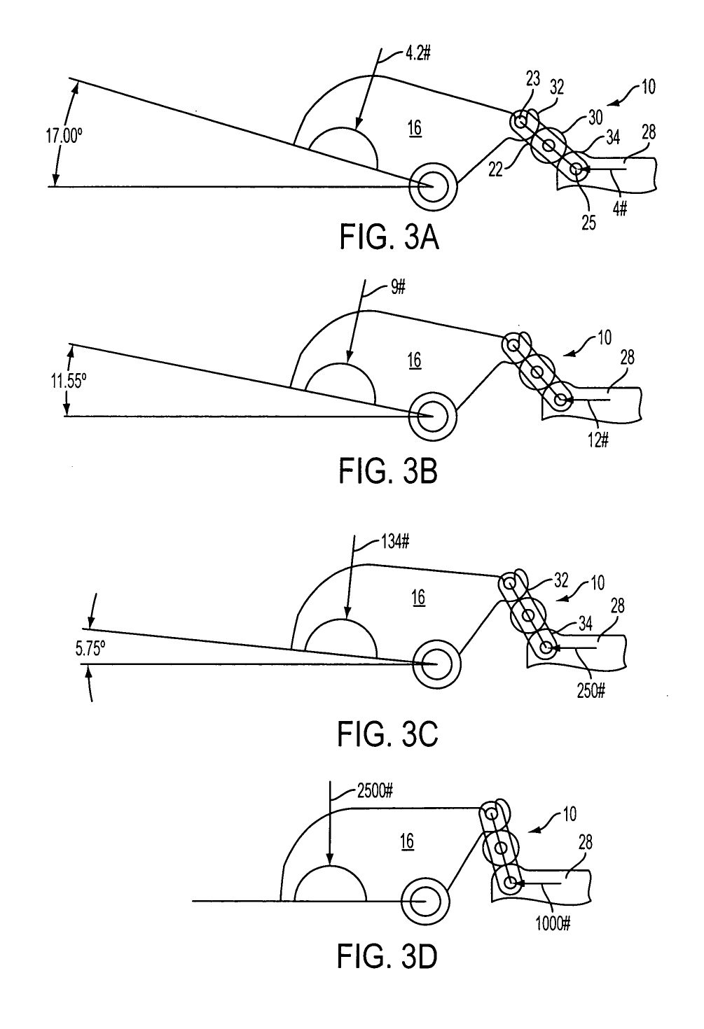

FIGS. 3a-3d show the crimping force provided by the force multiplying structure 10 during various operating stages when coupled with an output shaft of the device described in commonly owned, U.S. patent application Ser. No. 11/401,314. Thus, as the jaws 16 and 18 are moved to a closed position about the object 14 (FIG. 3d), a 1000-pound input force via shaft 28 results in a 2500-pound crimping force on the object 14. It can be appreciated that the output shaft 28 can be part of, or connected to, an output shaft of a device such as disclosed in the U.S. Pat. No. 6,341,621 patent as well.

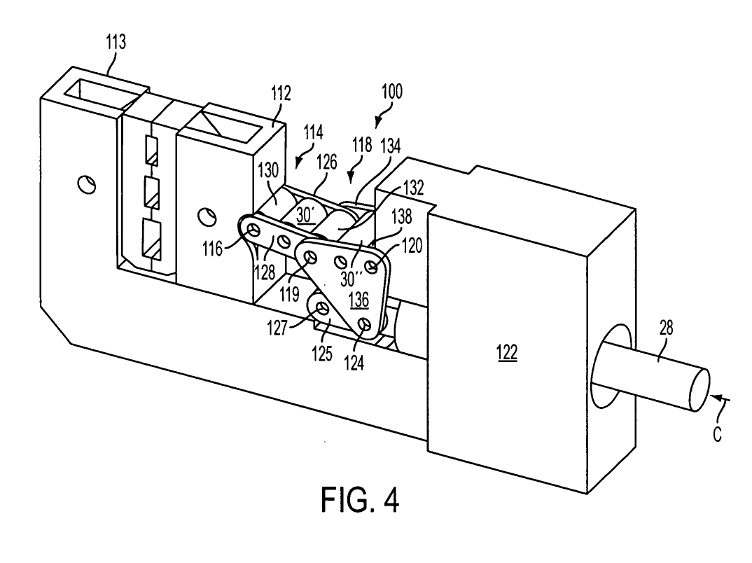

Although the force multiplying structure 10 is shown in FIGS. 1-3d for use in pivoting a pair of jaws of a crimping tool, with reference to FIG. 4, another embodiment of a force multiplying structure is shown generally indicated at 100. Force multiplying structure 100 causes a first member or a crimping tool jaw 112 to move generally linearly towards a fixed jaw 113 to crimp, for example, electrical terminal connectors. Thus, the structure 100 includes a first link structure 114 pivotally connected at one end to jaw 112 via connection 116 and pivotally connected at the other end to an end of the second link structure 118 via connection 119. A central cam 132 is also provided at connection 119, the function of which will be explained below. The other end of the second link structure 118 is pivotally connected via connection 120 to a second member such as fixed portion of a crimping tool 122. The second link structure is also pivotally connected via connection 124 to crank arm 125 (FIG. 6) that is that is pivotally coupled via connection 127 to an output shaft 28, such as the output shaft of the tool of the U.S. Pat. No. 6,341,621 patent.

In the embodiment, the first link structure 114 includes a pair of links 126 and 128 disposed in spaced relation. A first roller 30′ is provided between the links 126 and 128 for rotation on a cam surface 130 of jaw 112 and on the central cam 132. In the embodiment, the second link structure 118 includes a pair of links 134 and 136 disposed in spaced relation. A second roller 30″ is provided between the links 134 and 136 for rotation on a cam surface 138 of the crimping tool 122 and on the central cam 132.

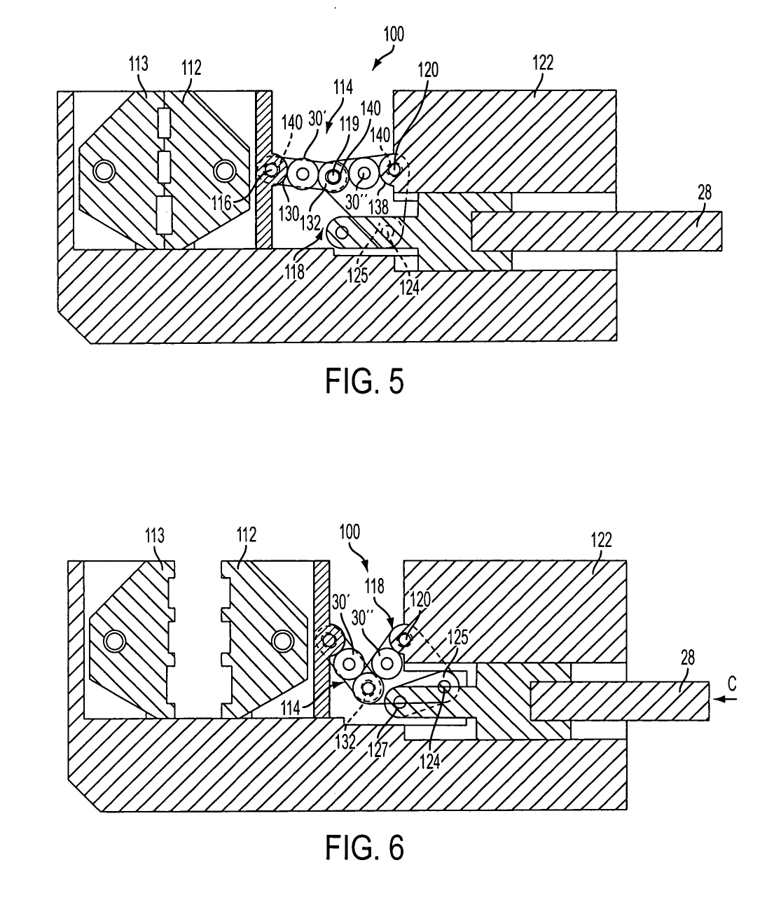

FIG. 6 shows the force multiplying structure 100 employed in the crimping tool with the jaws 112, 113 in an opened position. When the output shaft 28 moves in the direction of arrow C, the crank arm 25 causes the second link structure 118 to pivot about connection 120 causing connection 24 to move downwardly in FIG. 6, causing the central cam 132 to move upwardly (FIG. 5). This movement in turn causes the jaw 112 to move towards fixed jaw 113 during a crimping operation. As with the embodiment of FIGS. 1-3d, the rollers 30′, 30″ ensure that the connections 116 and 120 at the ends of each link structure 114, 118 do not carry an excessive load. As best shown in FIG. 5, slots 140 are provided at connections 116, 119 and 120 to permit the rollers 30′ 30″, not the link structures 114, 118 to carry the entire load.

Since the crank arm 125 is connected with the output shaft 28 it can be considered to be associated with or part of the output shaft. Furthermore, since the central cam 132 is connected with the second link structure 118 which is connected to the crank arm 125, the central cam 132 can be considered to be associated with the output shaft 28.

The embodiment of FIGS. 1 and 4 can each be considered to be a double link structure that is hinged in the middle with a roller provided in each link structure. The rollers are constructed and arranged to advantageously take up the entire load exerted on the first and second link structures.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A force multiplying structure for multiplying force from an output shaft to a tool, the tool including first and second members with at least one of the members being a movable member to exert the multiplied force on an object, each of the first and second members having a cam surface, the force multiplying structure comprising:
a central cam associated with the output shaft,
a first link structure having one end pivotally coupled to the first member and another end pivotally coupled with respect to the central cam,
a first roller associated with the first link structure for rotation with respect thereto, the first roller being disposed so as to rotate on the cam surface of the first member and on a surface of the central cam,
a second link structure having one end pivotally coupled to the second member and another end pivotally coupled with respect to the central cam, and
a second roller associated with the second link structure for rotation with respect thereto, the second roller being disposed so as to rotate on the cam surface of the second member and on a surface of the central cam,
whereby movement of the output shaft causes the first and second link structures to move thereby causing the movable member to move and engage the object with a force increased from a force exerted by the output shaft, with the rollers carrying loads exerted on the first and second link structures.

2. The structure of claim 1, wherein the first and second members are pivotally connected so as to be movable towards and away from each other, whereby linear movement of the output shaft causes rotation of the first and second members.

3. The structure of claim 2 in combination with the tool, wherein the first and second members are constructed and arranged to crimp the object placed there-between when the first and second members move towards each other.

4. The structure of claim 2, wherein the central cam is part of the output shaft.

5. The structure of claim 1, wherein each of the first and second link structures includes a pair of links, with the associated roller disposed between the links of a pair of links.

6. The structure of claim 5, wherein the first and second rollers are each of elongated cylindrical shape.

7. The structure of claim 1, wherein the first member is the movable member and linear movement of the output shaft causes linear movement of the first member.

8. The structure of claim 7, in combination with the tool, the tool including a fixed jaw member, the first member including a jaw member constructed and arranged to crimp the object between jaw members when the first member is moved linearly towards the fixed jaw member.

9. The structure of claim 8, wherein the ends of the first and second link structures that are coupled with respect to the central cam share a common pivot connection with the central cam.

10. The structure of claim 9, further comprising a crank arm pivotally coupled between the output shaft and the second link structure such that movement of the output shaft in a certain direction permits the crank arm to cause the second link structure to rotate with respect to the second member causing the central cam to move generally upwardly thus causing the first link structure to move the first member linearly.

11. A force multiplying structure for applying force from an output shaft to a tool, the tool including first and second members with at least one of the members being a movable member to exert the multiplied force on an object, each of the first and second members having a cam surface, the force multiplying structure comprising:
a central cam associated with the output shaft,
a first link structure having one end pivotally coupled to the first member and another end pivotally coupled with respect to the central cam,
first means associated with the first link structure for rotating with respect thereto, the first means being disposed so as to rotate on the cam surface of the first member and on a surface of the central cam,
a second link having one end pivotally coupled to the second member and another end pivotally coupled with respect to the central cam, and
second means associated with the second link structure for rotating with respect thereto, the second means being disposed so as to rotate on the cam surface of the second member and on a surface of the central cam,
whereby movement of the output shaft causes the first and second link structures to move thereby causing the movable member to move and engage the object with a force increased from a force exerted by the output shaft, with the first and second means carrying loads exerted on the first and second link structures.

12. The structure of claim 11, wherein the first and second members are pivotally connected so as to be movable towards and away from each other, whereby linear movement of the output shaft causes rotation of the first and second members.

13. The structure of claim 12 in combination with the tool, wherein the first and second members are constructed and arranged to crimp the object placed there-between when the first and second members move towards each other.

14. The structure of claim 13, wherein the central cam is part of the output shaft.

15. The structure of claim 11, wherein each of the first and second link structures includes a pair of links, with the associated means for rotating being disposed between the links of a pair of links.

16. The structure of claim 15, wherein the first and second means for rotating are each of elongated cylindrical shape.

17. The structure of claim 11, wherein only the first member is movable and linear movement of the output shaft causes linear movement of the first member.

18. The structure of claim 17, in combination with the tool, the tool including a fixed jaw member, the first member including a jaw member constructed and arranged to crimp the object between jaw members when the first member is moved linearly towards the fixed jaw member.

19. The structure of claim 18, wherein the ends of the first and second link structures that are coupled with respect to the central cam share a common pivot connection with the central cam.

20. The structure of claim 19, further comprising a crank arm pivotally coupled between the output shaft and the second link structure such that movement of the output shaft in a certain direction permits the crank arm to cause the second link structure to rotate with respect to the second member causing the central cam to move generally upwardly thus causing the first link structure to move the first member linearly.
